(19) United States
(12) Patent Application Publication
(10) Pub. No.: US 2007/0251051 A1
(43) Pub. Date: Nov. 1, 2007

(54) Door closer

(76) Inventor: Sugaya Miyashita, Osaka-fu (JP)

Correspondence Address: BERENATO, WHITE & STAVISH, LLC, 6550 ROCK SPRING DRIVE, SUITE 240, BETHESDA, MD, 20817, US

(21) Appl. No.: 11/527,595

(22) Filed: Sep. 27, 2006

(30) Foreign Application Priority Data
Apr. 27, 2006 (JP) 2006-123356

(51) Int. Cl. E05F 1/10

(52) U.S. Cl. 16/79

(57) ABSTRACT

A door closer is used for energizing a door in the direction closing the door, and the door closer has a door-closer main body installed on the door. The door-closer main body includes a hydraulic cylinder. A piston is placed within the hydraulic cylinder for being energized by an elastic body and which has a gear portion formed around its periphery. A gear body is pivoted by the hydraulic cylinder and which engages the gear portion of the piston to cause the piston to slide. A restricting mechanism temporarily restricts the rotation of the gear body when the door is opened.

### BACKGROUND OF THE INVENTION

1. Field of the Invention

The present invention relates to a door closer used for energizing a door in the direction closing the door, and more particularly, relates to a door closer arranged to temporarily restrict the movement of a door in the closing direction when the door was opened.

2. Description of the Related Art

Conventionally, door closers for energizing a door in the direction that closes the door are in very general use. This type of door closer has the function of shock-absorbingly energizing the door in the closing direction after the door was opened to make the door mechanically close in a smooth manner.

A conventional door closer is arranged to close the door just after the door was opened. Alternatively, the other conventional door closer is arranged such that the closer can hold the door in the opened position, and when a person energized the door in the closing direction, the closer can mechanically close the door.

However, the door closed immediately after the door was opened is dangerous when a person carries baggage into a room, and many persons or a person in a wheelchair enters or goes out of a room, for example. Further, even in the case in which the door is held in the opened state, the manually-energizing operation after passing by the door is burdensome. Consequently, an excellent way of sidestepping such trouble has been desired. Moreover, there is the potential of forgetting to close the opened door, and leaving the door in the wide-opened state causes a security problem. Furthermore, leaving the door in fully open condition gives rise to a loss of power for air-conditioners. This increases the air conditioning cost and also increases the possibility of causing global warming.

For this reason, a door closer has been sought, which can hold the door against return movement after the door was opened, and release the door after a certain period of time to make the door mechanically close.

The assignee has applied for two patents (Japanese Patent Application Nos. 2005-308456 and 2005-356164) for door closers that can hold the door against closing movement when the door was opened, and release the door when a predetermined time passed after that to cause the door to mechanically close.

Japanese Patent Application No. 2005-308456 discloses a door closer that is arranged to cause the door to mechanically close when a certain period of time passed after the door had been opened, by being equipped with a delay mechanism using a planetary gear unit and a spring.

Japanese Patent Application No. 2005-356164 discloses a door closer arranged to make the door mechanically close when a predetermined time passed after the door opening, by being provided with a delay mechanism using a solenoid and a timer.

As described hereinabove, both of Japanese Patent Application Nos. 2005-308456 and 2005-356164 disclose a door closer that can hold a door against return movement after the door was opened, and release the door, when a predetermined time passed after that, to make the door mechanically close.

Japanese Patent Application No. 2005-356164 in particular can provide a door closer, which is of simple structure and of low-cost in addition to having the above-described advantage.

However, the above-described door closers have a structure in which a conventional door closer is equipped with a delay mechanism. As a result, there is a problem that these door closers have an undesirable appearance because of the attached delay mechanism thereto, and further have comparatively large overall-dimensions.

### SUMMARY OF THE INVENTION

In view of the foregoing, an object of the present invention is to provide a door closer which can temporarily restrict the movement of a door in the closing direction when the door was opened and which has a simple structure and an excellent appearance.

In order to solve the above-mentioned problems, the present invention provides the following configurations.

In accordance with one aspect of the present invention, there is provided a door closer that is used for energizing a door in the direction closing the door, wherein the door closer has a door-closer main body installed on the door, and the door-closer main body includes: a hydraulic cylinder; a piston which is placed within the hydraulic cylinder by being energized by an elastic body and which has a gear portion engraved around the periphery of the piston; a gear body which is pivoted by the hydraulic cylinder and which engages the gear portion of the piston to cause the piston to slide; and a restricting means that temporarily restricts the rotation of the gear body when the door was opened.

In accordance with an additional aspect of the present invention, there is provided a door closer, wherein the door-closer main body rockably pivotally supports one end of a lever fixed to the gear body, the other end of the lever rotatably pivotally supports one end of an arm, and the other end of the arm is rockably pivoted by a to-wall fastening stay fixed to a wall.

In accordance with an additional aspect of the present invention, there is provided a door closer, wherein the restricting means includes: a cam portion formed around the gear body; an adjusting pin that is energized by an elastic body to press the cam portion; and an adjusting screw that adjusts the pressure of the adjusting pin by pressing this elastic body, and the head of the adjusting screw is exposed at one end of the door-closer main body.

In accordance with an additional aspect of the present invention, there is provided a door closer, wherein two said restricting means are individually provided in the respective right and left portions of the door-closer main body with the heads of the adjusting screws thereof individually exposed at the respective right and left ends of the door-closer main body, and thereby, it is arranged that the adjusting screws can be adjusted from either of the right and left ends of the door-closer main body.

In accordance with an additional aspect of the present invention, there is provided a door closer, wherein the restricting means includes: a sub-hydraulic cylinder attached to the hydraulic cylinder; a sub-piston which is placed within the sub-hydraulic cylinder by being energized by an elastic body and which includes a movable gear portion that is free to engage the gear body, around the periphery of the sub-piston; and a lock pin which is placed within the sub-hydraulic cylinder and which is free to project into the hydraulic cylinder by being energized by an elastic body, and the lock pin is provided with a cam portion, and the front end of the sub-piston is provided with a protrusion that engages in the cam portion thereof to press back the lock pin.

In accordance with an additional aspect of the present invention, there is provided a door closer, wherein the restricting means includes: a lock groove provided in the rear-end portion of the piston; a lock ball which is provided in a cover blocking the rear end of the hydraulic cylinder and which is free to engage in the lock groove by being energized by an elastic body; and an adjusting screw adjusting the pressure of this elastic body.

### BRIEF DESCRIPTION OF THE DRAWINGS

FIG. 1 is an oblique view showing a door closer according to a first embodiment of the present invention;

FIG. 2A is a left side view of a door-closer main body according to the first embodiment of the present invention;

FIG. 2B is a front view of the door-closer main body according to the first embodiment of the present invention;

FIG. 2C is a right side view of the door-closer main body according to the first embodiment of the present invention;

FIG. 3A is a cross-sectional view taken along the line A-B of FIG. 2B;

FIG. 3B is a cross-sectional view taken along the lines C-D-E-F of FIG. 2A;

FIG. 3C is a cross-sectional view taken along the lines G-H-I-J of FIG. 2C;

FIG. 4A is a left side view of a door-closer main body according to a second embodiment of the present invention;

FIG. 4B is a front view of the door-closer main body according to the second embodiment of the present invention;

FIG. 5A is a cross-sectional view taken along the line A-B of FIG. 4A in the closed condition of the door;

FIG. 5B is a cross-sectional view taken along the line A-B of FIG. 4A in the condition where the door is opened 90 degrees;

FIG. 6A is a cross-sectional view taken along the line C-D of FIG. 4A;

FIG. 6B is a cross-sectional view taken along the line E-F of FIG. 4A;

FIG. 6C is a fragmentary cross-sectional view taken along the line E-F of FIG. 4A in the condition where the door is opened 90 degrees;

FIG. 6D is a front view of the leaf-spring sleeve shown in FIGS. 5A and 5B;

FIG. 6E is a side view of the leaf-spring sleeve shown in FIGS. 5A and 5B;

FIG. 6F is a plan view of the leaf-spring sleeve shown in FIGS. 5A and 5B;

FIG. 7A is a left side view of a door-closer main body according to a third embodiment of the present invention;

FIG. 7B is a front view of the door-closer main body according to the third embodiment of the present invention;

FIG. 7C is a right side view of the door-closer main body according to the third embodiment of the present invention;

FIG. 8A is a cross-sectional view taken along the line A-B of FIG. 7B;

FIG. 8B is a cross-sectional view taken along the line C-D of FIG. 8A; and

FIG. 8C is an fragmentary cross-sectional view of the E portion of FIG. 8A.

### DETAILED DESCRIPTION OF THE PREFERRED EMBODIMENT(s)

An embodiment of the present invention will now be described by reference to the drawings where the embodiment is shown hereinbelow.

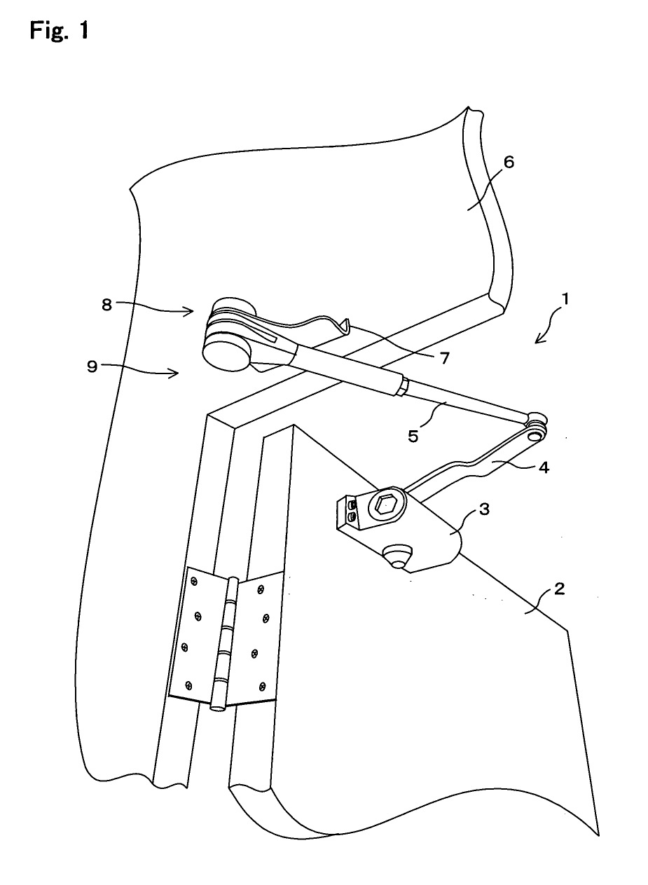

In FIG. 1, the reference numeral 1 indicates a door closer according to the present invention, and the door closer 1 includes: a door-closer main body 3 according to the first embodiment of the present invention, installed on a door 2; a lever 4 rockably pivoted by the door-closer main body 3; an arm 5 rotatably pivoted by the lever 4; and a to-wall fixing stay 7 which is attached to a wall 6 and which rockably pivotally supports the arm 5.

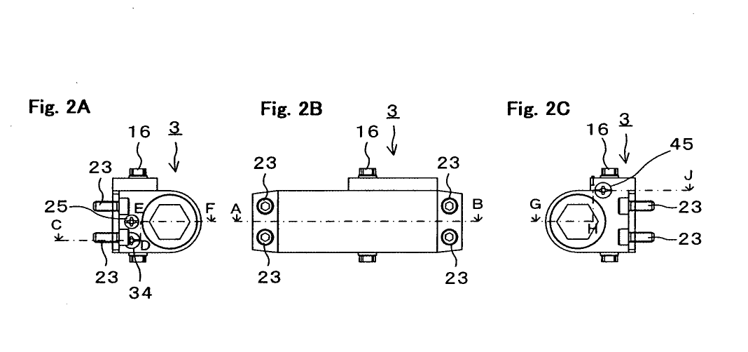

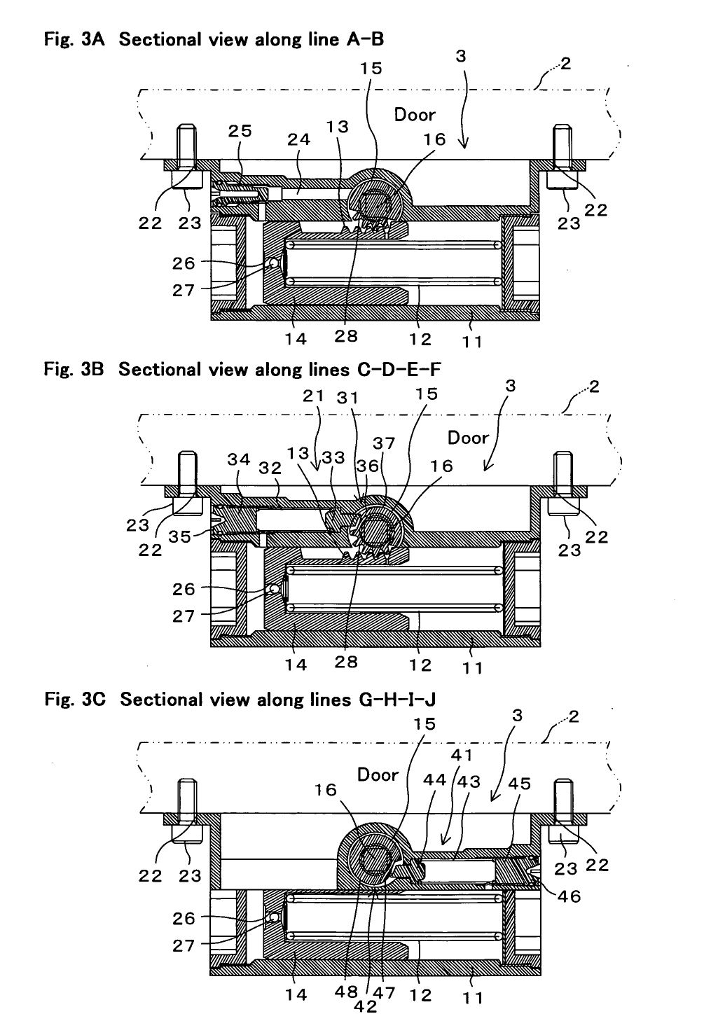

Further, the door-closer main body 3 shown in FIGS. 2A, 2B, and 2C, includes: as shown in FIGS. 3A, 3B, and 3C, a hydraulic cylinder 11; a piston 14 which is placed within the hydraulic cylinder 11 for being energized by an elastic body 12 and which is provided with a gear portion 13 formed around the periphery thereof; a gear body 15 which is pivoted by the hydraulic cylinder 11 and which engages the gear portion 13 of the piston 14 to cause the piston 14 to slide; and a restricting means 21 which temporarily restricts the rotation of the gear body 15 when the door 2 is opened.

The hydraulic cylinder 11 is arranged to be provided, at the both ends thereof, with screw holes 22, 22 used for attaching the cylinder to the door 2 by bolts 23, 23.

Furthermore, the sidewall portion of the hydraulic cylinder 11 is equipped with an oil passage 24 connecting the front-end side and the rear-end side of the piston 14, and the oil passage 24 is provided with an oil-amount-adjusting screw 25 for adjusting the amount of oil flowing in the oil passage 24, at the halfway point of its length.

The center of the front end of the piston 14 is provided with a through hole 26 extending therethrough from the front end of the piston 14 to the rear end thereof, and the through hole 26 is equipped with a ball 27 placed therein. It is arranged that, when the ball 27 travels rightward in the through hole 26, the ball blocks the through hole 26. That is, the through hole 26 and the ball 27 jointly have the function of a check valve.

The gear body 15 is equipped with a gear portion 28 which engages the gear portion 13 and which is engraved or otherwise formed around half the periphery of the gear body, which is opposed to the gear portion 13. The rotation axis 16 of the gear body 15 is placed through the door-closer main body 3, outwardly extruding from the main body, and is fastened to the lever 4.

The restricting means 21 includes, as best shown in FIG. 3B, a cam portion 31 formed around the other half-periphery of the gear body 15 where the gear portion 28 is not formed; an adjusting pin 33 that is energized by an elastic body 32 to press the cam portion 31; and an adjusting screw 34 for adjusting the pressure of the adjusting pin 33 by pressing the elastic body 32, with the adjusting pin 33, the elastic body 32, and the adjusting screw 34 all being provided on the left, as viewed in the figure showing the gear body 15, and with the head 35 of the adjusting screw 34 being exposed in the left-end portion of the door-closer main body 3.

The cam portion 31 has a cam structure in which a diameter-enlarged portion 37 is formed with the diameter clockwise enlarged gradually from a diameter-reduced portion 36, around the other half-periphery thereof where the gear portion 28 is not formed. In addition, the diameter-enlarged portion 37 is formed in the vicinity of the terminal point to which the cam portion 31 can rotate.

Meanwhile, as best shown in FIGS. 3B and 3C, a restricting means 41, which is of generally similar construction to the restricting means 21, is provided on the right of the gear body 15 on the rather front side, as viewed in the figure showing the restricting means 21. The restricting means 41 includes a cam portion 42 that is formed in the shape, which is generally similar to the construction obtained by enlarging the cam portion 31 in a direction axially of the gear body 15; an adjusting pin 44 that is energized by an elastic body 43 to thereby press the cam portion 42; and an adjusting screw 45 that adjusts the pressure of the adjusting pin 43 by pressing the elastic body 43, with the head 46 of the adjusting screw 45 being exposed in the right-end portion of the door-closer main body 3.

The cam portion 42 also has a cam structure in which a diameter-enlarged portion 48 is formed with the diameter clockwise enlarged gradually from a diameter-reduced portion 47, similarly as the cam portion 31 does. Additionally, the diameter-enlarged portion 48 is formed in the vicinity of the terminal point to which the cam portion 42 can rotate.

Accordingly, with the door-closer main body 3, the rotating speed of the gear body 15 can be adjusted by adjusting the adjusting screws 34 or 45 from both of the right and left ends of the main body 3.

The operation of the door-closer main body 3 will now be described. When the door 2 was opened to cause the lever 4 to rock about the door-closer main body 3 and thereby the gear body 15 rotated, the gear portion 28 of the gear body 15 engaged the gear portion 13 of the piston 14 to cause the piston 14 to slide rightwardly, as viewed in FIG. 3B.

At that time, the ball 27 moves leftward, and allows rotation of the piston 14.

Further, the adjusting pin 33 abuts the cam portion 31 at new positions from the diameter-reduced portion 36 thereof to the diameter-enlarged portion 37 thereof. When the adjusting pin 33 abutted the diameter-enlarged portion 37, the adjusting pin 33 is pressed by the diameter-enlarged portion 37, thus increasing the reaction force of the elastic body 42. This makes rotation of the door 2 slightly hard; however, the door 2 can be opened up to 90 degrees.

Subsequently, when the hand having opened the door 2 is released therefrom with the door in the open position, the piston 14 begins to move leftward, as viewed in the figure, by means of the restoring force of the elastic body 12. At that time, the adjusting pin 33 is pressed by the diameter-enlarged portion 37 of the cam portion 31 to thereby cause the force of the elastic body 32 to offer resistance to the rotation of the gear body 15, which reduces the rotating speed of the gear body 15. Consequently, the rotation of gear body 15 is decelerated, thus reducing the rotation of the door 2 in a door closing direction. As a result, the time which the door 2 takes to close is temporarily delayed. After that, when the diameter-enlarged portion 37 of the cam portion 31 went through the position of the adjusting pin 33, the gear body 15 goes out of the deceleration condition, and returns to the normal rotation condition, thus making the door 2 rotate at the normal speed in the closing direction.

By contrast, when the door 2 was opened and thereby the piston 14 slid rightward, as viewed in FIG. 3C, the adjusting pin 44 abuts the cam portion 42 at new positions from the diameter-reduced portion 47 thereof to the diameter-enlarged portion 48 thereof. When the adjusting pin 44 abutted the diameter-enlarged portion 48, the adjusting pin 33 is forced by the diameter-enlarged portion 37 to increase the reaction force of the elastic body 42, thus making the door 2 rather heavy to be opened; however, the door 2 can be opened through 90 degrees.

After that, when the hand having opened the door 2 was released therefrom with the door in the open position and the piston 14 has begun to travel leftward, as viewed in the figure, by the restoring force of the elastic body 12, the adjusting pin 44 presses the diameter-enlarged portion 48 of the cam portion 42, thus causing the force of the elastic body 43 to give resistance to the rotation of the gear body 15, thereby restricting the rotation of the gear body 15. Consequently, the rotation speed of the gear body 15 is reduced, and the rotation speed of the door 2 in the closing direction is thereby reduced. This temporarily delays the time which the door 2 takes to close. Then, when the point abutting the adjusting pin 44 moved from the diameter-enlarged portion 48 of the cam portion 42 to the diameter-reduced portion 47 thereof, the gear body 15 goes out of the deceleration position, and thereby normally rotates. This causes the door 2 to rotate at the normal speed in the direction closing the door.

Both the restricting means 21 and 41 can be operated at the same time, and either restricting means may be operated by adjusting the adjusting screw 34 or 45.

In addition, when the piston 14 travels rightward as viewed in the figure, the ball 27 moves leftward, thus not blocking the through hole 26. The pressurized oil can flow in the through hole 26, and the piston 14 can smoothly slide.

By contrast, when the piston 14 traveled leftward, as viewed in the figure, the ball 27 travels rightward to thereby block the through hole 26, thus interfering with the slide of the piston 14. However, the pressurized oil flows from the front-end side of the piston 14 to the rear-end side thereof through the oil passage 24, which enables the piston 14 to leftward travel. However, the adjustment of the oil amount by adjusting the oil-amount-adjusting screw 25 can control the speed of the piston 14.

Additionally, the above-described door-closer main body 3 was equipped with the restricting means 21 and 42; however, optionally, either of them may be installed. At that time, a similar effect can be also obtained. However, the adjustment of the adjusting screw of the restricting means can be performed only on the one end side of the door-closer main body 3 on which the restricting means was provided.

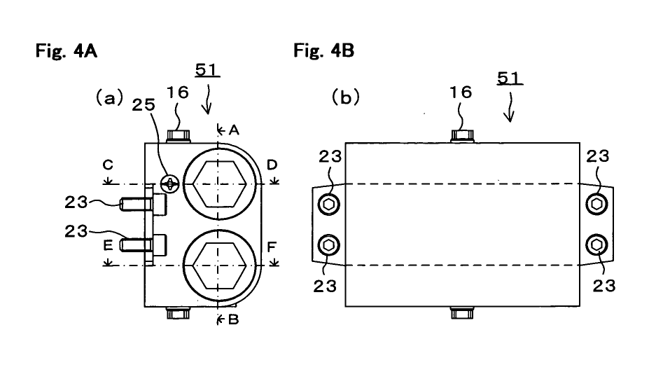

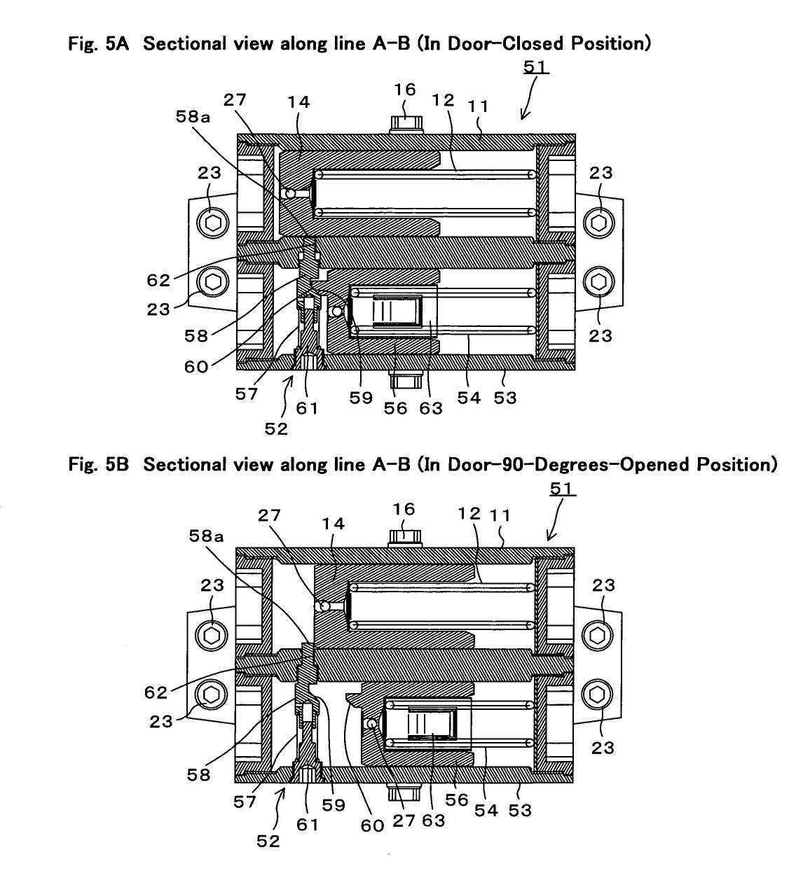

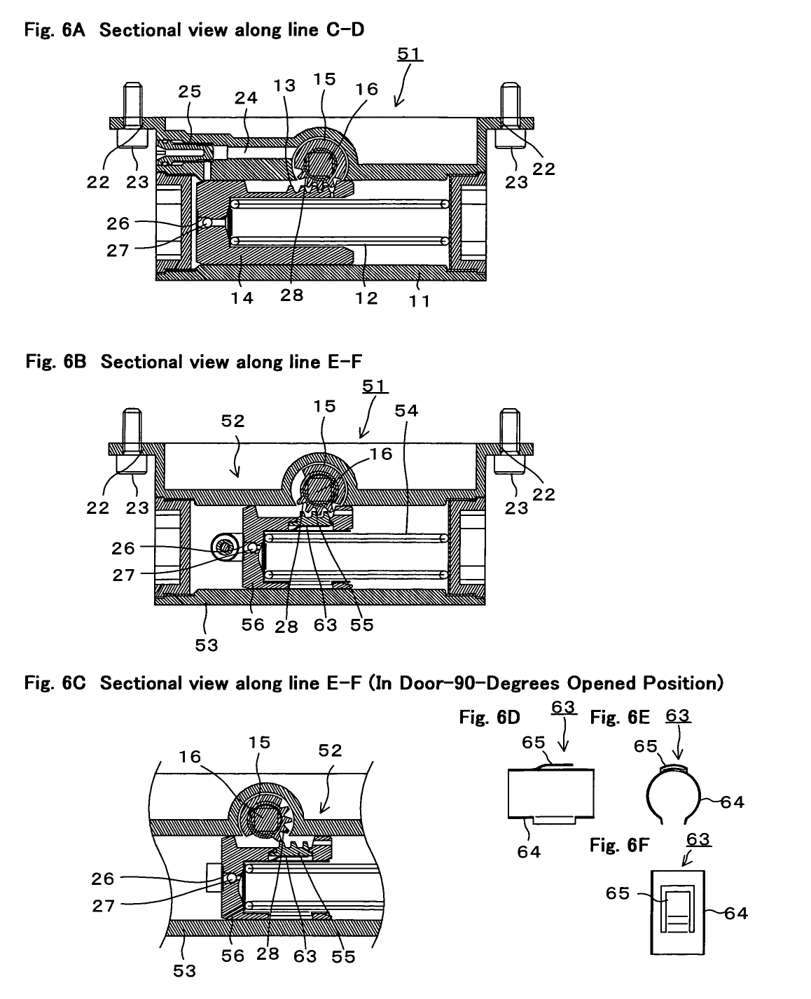

In FIGS. 4A and 4B, the reference numeral 51 indicates a door-closer main body according to the second embodiment of the present invention. The door-closer main body 51 is provided with a restricting means 52 as best shown in FIGS. 5A, 5B, 6A, and 6B in place of the restricting means (designated by the numeral 21 in FIG. 3B and the numeral 41 in FIG. 3C) of the door-closer main body (indicated by the numeral 3 in FIGS. 2A, 2B, and 2C) according to the first embodiment.

The restricting means 52 includes a sub-hydraulic cylinder 53 attached parallel to and under the hydraulic cylinder 11; a sub-piston 56 which is placed within the sub-hydraulic cylinder 53 for being energized by an elastic body 54 and which is provided with a movable gear portion 55, which is free to engage the gear body 15, around the periphery thereof; and a lock pin 58 which is placed within the sub-hydraulic cylinder 53 and which is free to project into the hydraulic cylinder 11 for being energized and upwardly forced by elastic body 57; with the lock pin 58 being provided with a cam portion 59, and with the front-end portion of the sub-piston 56 being provided with a protrusion 60, which engages in a cam portion 59 to downwardly force (press back) the lock pin 58.

In further detail, the lock pin 58 is slidably provided on a holder 61, which is provided within the sub-hydraulic cylinder 53 upwardly protruding therefrom as viewed in the figure, and further, the lock pin is upwardly energized by the elastic body 57 provided in the holder 61, with the top of the lock pin 58 being arranged to be free to protrude into the hydraulic cylinder 11 through a through hole 62, which is formed extending through the sub-hydraulic cylinder 53 to the hydraulic cylinder 11. In addition, the through hole 62 is formed in the vicinity of the sliding right end in the front-end portion of the piston 14.

Further, the cam portion 59 is formed on the side of the lock pin 58 such that the cam portion has a cavity opening toward the piston 56, and the concave underside of the cam portion is obliquely right-downward formed.

Meanwhile, the underside of the protrusion 60 thereof is obliquely left-upwardly formed, and when the protrusion 60 is engaged in the cam portion 59, the obliquely formed underside of the protrusion 60 downwardly presses the obliquely formed underside of the cam portion 59, thus downwardly forcing the lock pin 58 in order for the top portion of the lock pin 58 not to protrude into the hydraulic cylinder 11.

Furthermore, the movable gear portion 55 is upwardly energized by a leaf-spring sleeve 63. The leaf-spring sleeve 63 is provided with a leaf spring 65 formed on the top end of a cylindrical sleeve 64 that is axially cut away, by notching the sleeve such that the leaf spring projects from the sleeve, as best shown in FIGS. 6D-6F.

The operation of the door-closer main body 51 will be described. When the door 2 is opened to cause the lever 4 to rock about the door-closer main body 51 and thereby the gear body 15 rotated, the gear portion 28 of the gear body 15 engages the gear portion 13 of the piston 14, thus sliding the piston 14 rightwardly, as viewed in FIG. 5A.

At that time, the movable gear portion 55 also engages the gear body 15, thus also causing the sub-piston 56 in the sub-hydraulic cylinder 53 to slide toward the right.

Moreover, when the piston 14 slides toward the right, the tip 58a of the lock pin 58 projects into the hydraulic cylinder 11, as best shown in FIG. 5B.

After that, when the hand having opened the door 2 is released therefrom with the door in the open position, the piston 14 travels leftward, as viewed in the figure, by means of the restoring force of the elastic body 12. Then, the piston 14 abuts against the tip 58a of the lock pin 58 at the position to which the piston moved a predetermined distance, and the piston stops thereat.

Meanwhile, the sub-piston 56 also travels toward the left, and the movable gear portion 55 of the sub-piston 56 downwardly moves by being forced by the gear portion 28 even after the piston 14 is stopped. This releases the engagement between the movable gear portion 55 and the gear portion 28, and causes the sub-piston 56 to continue the leftward travel, engages the protrusion 60 of the sub-piston 56 in the cam portion 59, and downwardly forces (or presses back) the lock pin 58. Thereby, the piston 11 moves toward the left, and the gear body 15 also rotates, thus closing the door 2.

Accordingly, for the duration of the time the piston 14 is stopped, the gear body 15 is held in the stopped position of the rotation, which temporarily restricts the rotation of the door 2.

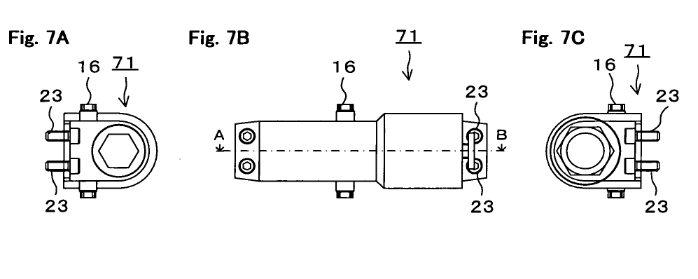

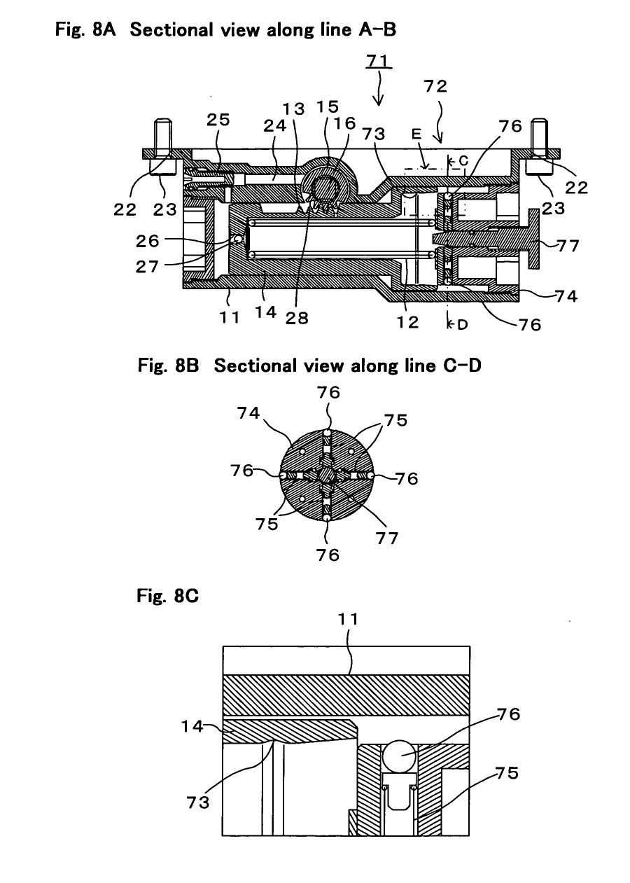

In FIGS. 7A-7C, the reference numeral 71 indicates a door-closer main body according to the third embodiment of the present invention. The door-closer main body 71 is provided, as shown in FIG. 8A, with a restricting means 72 described hereinafter in place of the restricting means (designated by the numeral 21 in FIG. 3B and the numeral 41 in FIG. 3C) of the door-closer main body (designated by the numeral 3 in FIGS. 2A-2C) according to the first embodiment.

The restricting means 72 includes a lock groove 73 provided in the rear-end portion of a piston 14; a lock ball 76 which is provided in a cover 74 blocking the rear end of a hydraulic cylinder 11 and which is free to engage in the lock groove 73 by being energized by an elastic body 75; and an adjusting screw 77 adjusting the pressure of the elastic body 75.

In further detail, the hydraulic cylinder 11 has the rear-end portion thereof diameter-enlarged. The piston 14 also has the rear-end portion thereof diameter-enlarged such that the rear-end portion of the piston is free to slide along the diameter-enlarged rear-end portion of the hydraulic cylinder 11, and the inner wall of the diameter-enlarged rear-end portion of the piston 14 is annularly provided with the lock groove 73.

Moreover, the cover 74 is provided in the hydraulic cylinder 11 such that the cover projects thereinto, and the projecting front-end portion of the cover 74 is sized so as to slide along the inner wall of the rear end of the piston 14 or to be inserted adjacent each other therein. The front-end portion of the cover 74 is equipped with four lock balls 76 disposed at equally spaced intervals around the periphery of front-end portion, and these lock balls 76 are radially outwardly energized by their respective elastic bodies 75. Additionally, the lock balls 76 are provided at the positions where the lock balls engage the lock groove 73 when the piston 14 is in the vicinity of the sliding right end thereof.

The operation of the door-closer main body 71 will now be described. When the door 2 is opened to cause the lever 4 to rock about the door-closer main body 71 and the gear body 15 thereby rotated, the gear portion 28 of the gear body 15 engages the gear portion 13 of the piston 14 to cause the piston 14 to slide rightwardly, as viewed in FIG. 8A.

At that time, when the front-end portion of the cover 74 is inserted in the diameter-enlarged rear-end portion of the piston 14 and the lock balls 76 engages the lock groove 73, the movement of the piston 14 is temporarily stopped or decelerated, and the gear body 15 and the door 2 are also placed in stopped or decelerated condition against rotation.

When the lock balls 76 disengages from the lock groove 73 by the force opening the door 2, the piston 14 moves toward the right again at the natural speed, and the gear body 15 rotates, thus opening the door 2 approximately 90 degrees.

Then, when the hand having opened the door 2 is released therefrom with the door 2 in the open position, the piston 14 begins to travel leftward, as viewed in the figure, by the restoring force of the elastic body 12. After that, when the lock balls 76 engaged the lock groove 73 at the position to which the piston 14 has moved a predetermined distance, the movement of the piston 14 is temporarily stopped or decelerated, and the gear body 15 and the door 2 are also placed in a stopped or decelerated position against rotation. After a certain period of time, when the lock balls 76 disengage from the lock groove 73 by the restoring force of the elastic body 12, the piston 14 restarts travel toward the left at the natural speed, the gear body 15 also similarly restarts the rotation, and the door 2 also rotates in the closing direction at the natural speed.

In addition, in the door-closer main body 71 according to the third embodiment, it may be arranged that the lock balls 76 engage the groove 73 immediately after the door 2 is opened 90 degrees.

What is claimed is:

1. A door closer that is used for energizing a door in the direction closing the door, wherein the door closer has a door-closer main body installed on the door, and the door-closer main body comprises:
a hydraulic cylinder;
a piston which is placed within the hydraulic cylinder by being energized by an elastic body and which is provided with a gear portion engraved around the periphery of the piston;
a gear body which is pivoted by the hydraulic cylinder and which engages the gear portion of the piston to cause the piston to slide; and
a restricting means that temporarily restricts the rotation of the gear body when the door was opened.

2. A door closer according to claim 1, wherein the door-closer main body rockably pivotally supports one end of a lever fixed to the gear body, the other end of the lever rotatably pivotally supports one end of an arm, and the other end of the arm is rockably pivoted by a to-wall fastening stay fixed to a wall.

3. A door closer according to claim 1, wherein the restricting means comprises:
a cam portion formed around the gear body;
an adjusting pin that is energized by an elastic body to press the cam portion; and
an adjusting screw that adjusts the pressure of the adjusting pin by pressing this elastic body, and
the head of the adjusting screw is exposed at one end of the door-closer main body.

4. A door closer according to claim 1, wherein two said restricting means are individually provided in the respective right and left portions of the door-closer main body with the heads of the adjusting screws thereof individually exposed at the respective right and left ends of the door-closer main body, and thereby, it is arranged that the adjusting screws can be adjusted from both of the right and left ends of the door-closer main body.

5. A door closer according to claim 1, wherein the restricting means comprises:
a sub-hydraulic cylinder attached to the hydraulic cylinder;
a sub-piston which is placed within the sub-hydraulic cylinder by being energized by an elastic body and which includes a movable gear portion that is free to engage the gear body, around the periphery of the sub-piston; and
a lock pin which is placed within the sub-hydraulic cylinder and which is free to project into the hydraulic cylinder by being energized by an elastic body, and
the lock pin is provided with a cam portion, and the front-end portion of the sub-piston is provided with a protrusion that engages in the cam portion thereof to press back the lock pin.

6. A door closer according to claim 1, wherein the restricting means comprises:
a lock groove provided in the rear-end portion of the piston;
a lock ball which is provided in a cover blocking the rear end of the hydraulic cylinder and which is free to engage in the lock groove by being energized by an elastic body; and
an adjusting screw adjusting the pressure of this elastic body.
